(19) United States
(12) Patent Application Publication
(10) Pub. No.: US 2016/0277724 A1
(43) Pub. Date: Sep. 22, 2016

(54) DEPTH ASSISTED SCENE RECOGNITION FOR A CAMERA

(71) Applicant: SONY CORPORATION, Minato-ku,Tokyo (JP)

(72) Inventor: Daniel Linåker, Lund (SE)

(73) Assignee: Sony Corporation, Tokyo (JP)

(21) Appl. No.: 14/433,174

(22) PCT Filed: Apr. 17, 2014
(86) PCT No.: PCT/JP2014/002191

§ 371 Date: Apr. 2, 2015

(51) Int. Cl. H04N 13/02; H04N 5/222; H04N 5/232

(52) U.S. Cl. CPC H04N 13/0271; H04N 5/23245; H04N 5/2226

(57) ABSTRACT

A digital camera is operated by calculating a digital depth map of a scene that is received by the camera. Based on the digital depth map of the scene, one of the available scene mode settings is automatically selected. Related methods, devices, and/or computer program product are described.

### TECHNICAL FIELD

Various embodiments described herein relate to operating a camera and more particularly to processing an image that is received by a camera.

### BACKGROUND ART

Digital cameras are used by casual users as well as professional photographers. Digital cameras may include features such as autofocus and face recognition to aid the operator in obtaining better quality pictures. The camera may include settings that the operator selects for modes such as macro, landscape, portrait, backlight, etc. However, the camera users are demanding higher quality pictures with less operator controlled settings and more automatic functionality such that the user may be more agnostic about the technical operation of the camera.

The approaches described in this section could be pursued, but are not necessarily approaches that have been previously conceived or pursued. Therefore, unless otherwise indicated herein, the approaches described in this section are not prior art to claims in this application and any application claiming priority from this application, and are not admitted to be prior art by inclusion of this section.

### SUMMARY

According to various embodiments described herein, operating a camera may include calculating a digital depth map of a scene that is received by the camera. Based on the digital depth map of the scene, one of a plurality of scene mode settings for the scene may be automatically selected.

In some embodiments, automatically selecting one of the plurality of scene mode settings may be preceded by determining an initial scene mode setting out of the plurality of scene mode settings, based on non-depth information related to the scene. The initial scene mode setting may be automatically changed based on the digital depth map of the scene.

According to some embodiments, automatically selecting one of the plurality of scene mode settings may further be based on non-depth information.

In some embodiments, the scene may include a plurality of pixels. Calculating the digital depth map may include calculating a depth value for one or more of the plurality of pixels in the scene.

According to some embodiments, the camera may include a plurality of independent image capturing systems. Calculating the digital depth map of a scene may include calculating the digital depth map of a scene from at least two of a plurality of independent image capturing systems. In some embodiments, calculating the digital depth map of a scene may be performed using only two of the plurality of independent image capturing systems.

According to some embodiments, calculating the digital depth map may include calculating a plurality of digital depth maps, a respective one of which is related to a respective frame of the scene. Automatically selecting one of the plurality of scene mode settings may include automatically selecting one of the plurality of scene mode settings based on the plurality of digital depth maps.

In some embodiments, calculating the digital depth map may include calculating a plurality of digital depth maps, a respective one of which is related to a respective frame of the scene. Automatically selecting one of the plurality of scene mode settings for the scene based on the digital depth map of the scene may include comparing one or more of the plurality of digital depth maps to determine the presence of motion in the scene. Based on at least one of the plurality of digital depth maps and the presence of motion in the scene, the scene mode setting may be automatically selected.

According to some embodiments, automatically selecting one of the plurality of scene mode settings for the scene based on the digital depth map of the scene may include identifying one or more objects in the scene based on the digital depth map. Depth values may be assigned to each of the one or more of the objects in the scene. One or more objects in the scene may be weighted based on the assigned depth values. Based on the respective weighting of the objects, the scene mode setting may be automatically selected.

According to some embodiments, identifying the one or more objects in the scene based on the digital depth map includes classifying one or more of a plurality of pixels in the scene into depth ranges based on the digital depth map. Based on the classification of the one or more of the plurality of pixels in the scene into depth ranges, one or more objects in the scene may be identified.

In some embodiments, weighting the one or more objects in the scene based on the assigned depth values includes determining the respective type of respective ones of the one or more objects in the scene. Based on the determined type of the respective ones of the one or more objects in the scene, priorities are assigned to the one or more objects in the scene. Based on the priorities that were assigned to the one or more objects, the one or more objects in the scene are weighted.

According to some embodiments, automatically selecting one of the plurality of scene mode settings for the scene based on the digital depth map of the scene includes classifying one or more of the plurality of pixels in the scene into depth ranges based on the digital depth map. Based on the classification of the one or more of the plurality of pixels into depth ranges, one or more pixels in the scene are weighted. Based on the weighting of the one or more pixels, the scene mode setting may be automatically selected.

In some embodiments, the scene mode setting may include sports mode, macro mode, movie mode, night mode, snow mode, document mode, beach mode, food mode, fireworks mode, smile detection mode, steady shot mode, landscape mode, portrait mode, aperture priority mode, shutter priority mode, and/or sensitivity priority mode. Automatically selecting one of the plurality of scene mode settings for the scene based on the digital depth map of the scene may include setting parameters related to shutter speed, aperture, white balance, color saturation, focus, and/or exposure.

It will be understood that various embodiments were described above in terms of methods of operating a camera. Analogous embodiments may be provided for a device, such as camera, according to any of the embodiments described herein. For example, a camera may include a computation unit and/or a selection unit configured to perform operations such as calculating a digital depth map, and automatically selecting a scene mode setting. Analogous embodiments may be provided for a computer program product according to any of the embodiments described herein. For example, a computer program product may include computer readable program code that is configured to calculate a digital depth map of a scene and/or automatically select one of a plurality of scene mode settings based on the digital depth map of the scene.

Other electronic devices, methods, and/or computer program products according to embodiments of the invention will be or become apparent to one with skill in the art upon review of the following drawings and detailed description. It is intended that all such additional electronic devices, methods, and/or computer program products be included within this description, be within the scope of the present invention, and be protected by the accompanying claims. Moreover, it is intended that all embodiments disclosed herein can be implemented separately or combined in any way and/or combination.

### BRIEF DESCRIPTION OF DRAWINGS

The accompanying drawings, which are included to provide a further understanding of the invention and are incorporated in and constitute a part of this application, illustrate certain embodiment(s) of the invention. In the drawings:

FIG. 1 is a simplified block diagram of a scene that may be analyzed by a camera, device, method and/or computer program product according to various embodiments described herein.

FIG. 2 is a simplified block diagram of multiple frames of a scene that may be analyzed by a camera, device, method and/or computer program product according to various embodiments described herein.

FIG. 3A is a simplified block diagram of a scene that may be analyzed by a camera, device, method and/or computer program product according to various embodiments described herein.

FIG. 3B is a simplified block diagram including a camera and screen displaying the captured scene.

FIG. 3C is a simplified block diagram of a device including a camera.

FIG. 3D is a simplified block diagram of a device interfacing to a camera, method and/or computer program product according to various embodiments described herein.

FIG. 4 is a simplified block diagram of a camera.

FIG. 5 is a flowchart of operations that may be performed to operate a camera to automatically select a scene mode setting based on a digital depth map by a system, method, device, and/or computer program product according to various embodiments described herein.

FIG. 6 is a flowchart of operations that may be performed to automatically select a scene mode setting based on the digital depth map by a system, method, device, and/or computer program product according to various embodiments described herein.

FIG. 7 is a flowchart of operations that may be performed to calculate a digital depth map of a scene by a system, method, device, and/or computer program product according to various embodiments described herein.

FIG. 8 is a flowchart of operations that may be performed to calculate a digital depth map of a scene by a system, method, device, and/or computer program product according to various embodiments described herein.

FIG. 9 is a flowchart of operations that may be performed to calculate a digital depth map of a scene by a system, method, device, and/or computer program product according to various embodiments described herein.

FIG. 10 is a flowchart of operations that may be performed to automatically select a scene mode setting based on the digital depth map by a system, method, device, and/or computer program product according to various embodiments described herein.

FIG. 11 is a flowchart of operations that may be performed to automatically select a scene mode setting based on the digital depth map by a system, method, device, and/or computer program product according to various embodiments described herein.

FIG. 12 is a flowchart of operations that may be performed to automatically select a scene mode setting based on the digital depth map by a system, method, device, and/or computer program product according to various embodiments described herein.

FIG. 13 is a flowchart of operations that may be performed to identify one or more objects in the scene based on the digital depth map by a system, method, device, and/or computer program product according to various embodiments described herein.

FIG. 14 is a flowchart of operations that may be performed to weight one or more objects in the scene based on the assigned depth values by a system, method, device, and/or computer program product according to various embodiments described herein.

FIG. 15 is a flowchart of operations that may be performed to automatically select a scene mode setting based on the digital depth map by a system, method, device, and/or computer program product according to various embodiments described herein.

FIG. 16 is a flowchart of operations that may be performed to automatically select a scene mode setting based on the digital depth map by a system, method, device, and/or computer program product according to various embodiments described herein.

### DESCRIPTION OF EMBODIMENTS

Various embodiments described herein can provide systems, methods and devices for operating a camera. Various embodiments described herein may be used, in particular with mobile devices such as mobile telephones or stand-alone cameras.

Various embodiments will now be described more fully hereinafter with reference to the accompanying drawings, in which examples of various embodiments are shown. This invention may, however, be embodied in many different forms and should not be construed as limited to the embodiments set forth herein. Rather, these embodiments are provided so that this disclosure will be thorough and complete, and will fully convey the scope of the present invention to those skilled in the art. It should also be noted that these embodiments are not mutually exclusive. Components from one embodiment may be tacitly assumed to be present/used in another embodiment.

For purposes of illustration and explanation only, these and other embodiments are described herein in the context of operating in a camera. It will be understood, however, that the present invention is not limited to such embodiments and may be embodied generally in any type of device that may benefit from inclusion of a camera. As used herein, a camera can include any device that receives image and/or scene data, and may include, but is not limited to, a mobile device (“cellular” telephone), laptop/portable computer, pocket computer, hand-held computer, desktop computer, a machine to machine (M2M) or MTC type device, a sensor with a communication interface, surveillance system sensor, standalone camera (point and shoot, single lens reflex (SLR), etc.), telescope, television cameras, etc. Moreover, the device may record or save the images for processing. In other embodiments, the device may not necessarily record or save the images but may capture and process the images and forward the processed images to another device. Examples of the camera could include array cameras that include multiple sub-cameras arranged in various configurations. The camera may include stereo cameras which comprise two cameras. A minimum of two cameras may be necessary to capture depth information according to various embodiments described herein. It will also be understood that the camera may include a processor, memory, and other resources appropriately scaled to accommodate the large amount of processing required to calculate and process depth maps as discussed herein.

A depth map is a two-dimensional (2D) array of values for mathematically representing a surface in space, where the rows and columns of the array correspond to the x and y location information of the surface and the array elements are depth or distance readings to the surface from a given point or camera location. A depth map can be viewed as a grey scale image of an object, with the depth information replacing the intensity and color information, or pixels, at each point on the surface of the object. A graphical representation of an object can be estimated by a depth map. However, the accuracy of a depth map may decline as the distances to the objects increase.

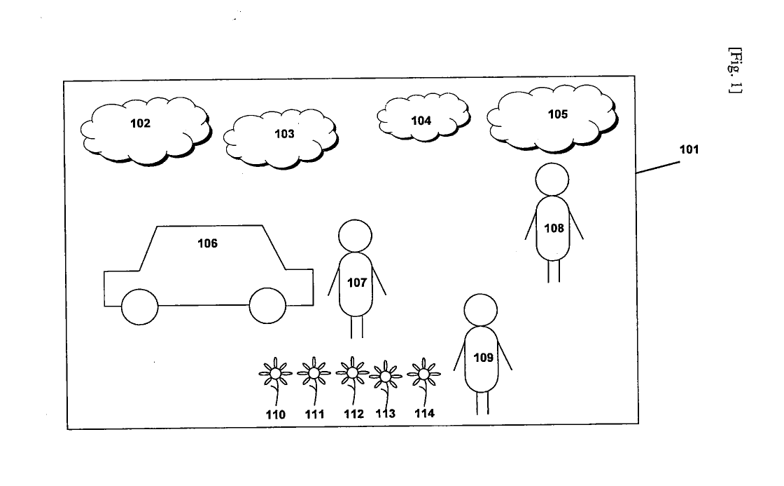

FIG. 1 is a simplified block diagram of a scene that may be analyzed by a camera system, method and/or computer program product according to various embodiments described herein. As shown in FIG. 1, a scene 101 is illustrated which may be captured by a camera. According to various embodiments described herein the camera may include one or more image capturing systems and/or subcameras. The scene 101 of FIG. 1 may include, for example, various objects such as an automobile 106, persons 107-109 who are in the scene at various distances from the image capturing system, flowers 110-114 which may be in the foreground, and clouds 102-105 in the background of the scene.

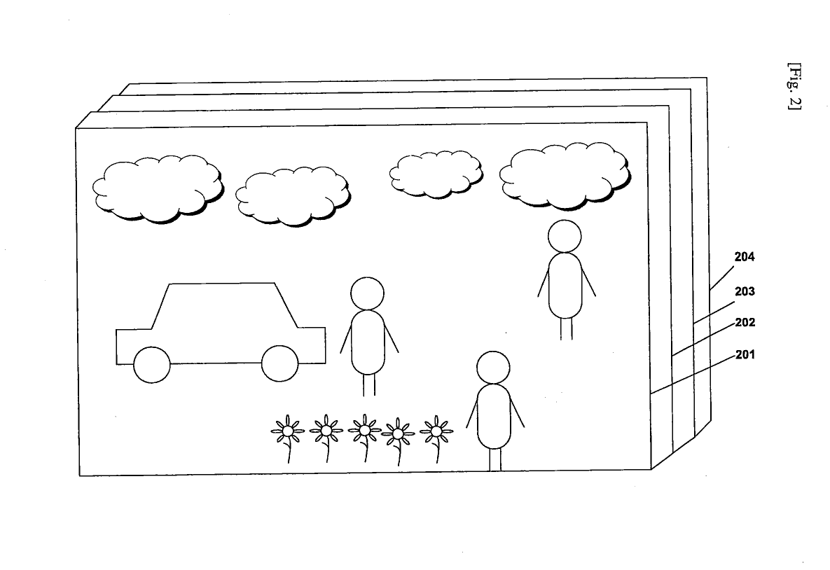

FIG. 2 is a simplified block diagram of multiple frames of a scene that may be analyzed by a camera, method and/or computer program product according to various embodiments described herein. Depending upon the capabilities and/or selected settings of the camera, multiple frames 201-204 may be captured at various frame time intervals. The time intervals between frames may be a constant value for applications such as video, or be varied based on analysis of the scene being captured. For example, an indication of motion in the scene may warrant a smaller time interval between the frames for which each scene is captured. Indication of little motion in the scene may allow for larger time intervals in order to reduce processing time and memory resources used by the camera.

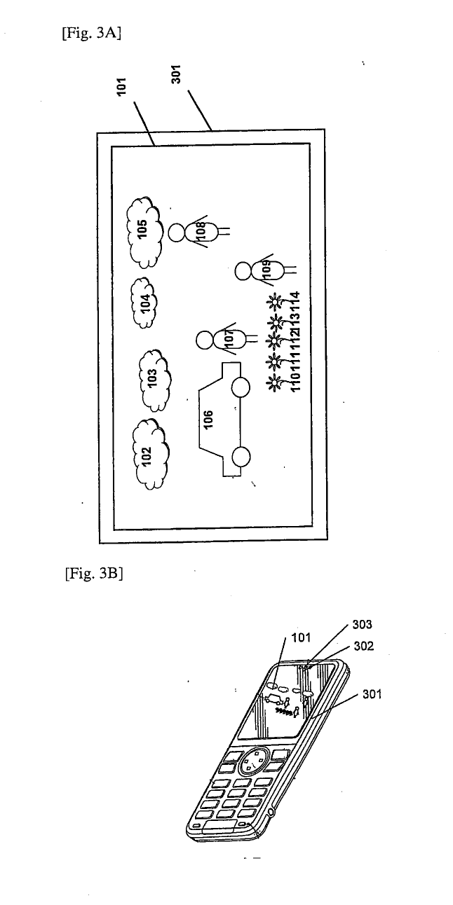

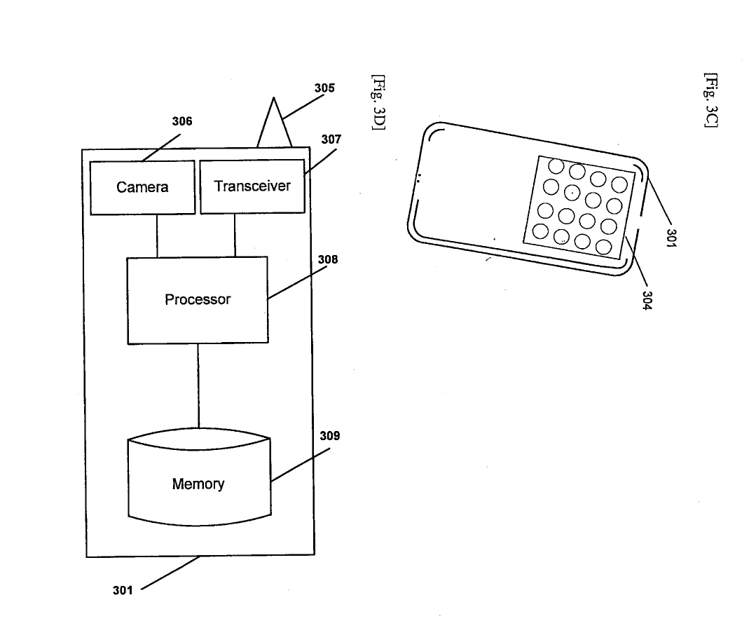

FIG. 3A is a simplified block diagram of a scene that may be analyzed by a camera, device, method and/or computer program product according to various embodiments described herein. FIG. 3A illustrates a mobile device 301 that may be configured to capture a scene 101. The mobile device 301 may include one or more image capturing systems. The scene 101 may be captured by an image capturing system, or be transmitted to the mobile device for processing.

FIG. 3B is a simplified block diagram including a camera and display screen displaying the captured scene. FIG. 3B illustrates a mobile device 301 that includes a display screen 302 and a camera 303. The camera may be a single lens camera, an array camera, a stereo camera, or any other type of camera system able to record depth information. While the camera 303 and display screen 302 are illustrated on the front side of the mobile device 301, the camera and display screen may be located anywhere on the device, including the back side.

FIG. 3C is a simplified block diagram of a device including a camera. FIG. 3C illustrates a mobile device 301 that includes a camera 304. The mobile device, according to some embodiments, may be a standalone camera. The camera may include one or more independent image capturing systems. The image capturing systems may include a single lens camera, an array camera, or a stereo camera. For example, the image capturing system may include 16 image capturing systems. Fewer or more independent image capturing systems may be used according to various embodiments described herein. While the camera 304 is illustrated on the back side of the mobile device 301, the camera may be located anywhere on the device, including the front side.

FIG. 3D is a simplified block diagram of a method, device, and/or computer program product according to various embodiments described herein. The illustrated mobile device 301 may represent devices that include any suitable combination of hardware, software, firmware, and/or circuitry, as well as standalone cameras. As shown in FIG. 3D, the example mobile device 301 includes a processor 308, a memory 309, a transceiver 307, and an antenna 305. The transceiver may include circuitry to provide wireless or wireline data transfer. The camera 306 may be inside the mobile device 301, outside the mobile device 301, or may remotely communicate with the mobile device 301. In particular embodiments, some or all of the functionality described above as being provided by mobile devices may be provided by the processor 308 executing instructions stored on a computer-readable medium, such as the memory 309 shown in FIG. 3D. Alternative embodiments of the device may include additional components beyond those shown in FIG. 3D that may be responsible for providing certain aspects of the mobile device's functionality, including any of the functionality described above and/or any functionality necessary to support the solution described above.

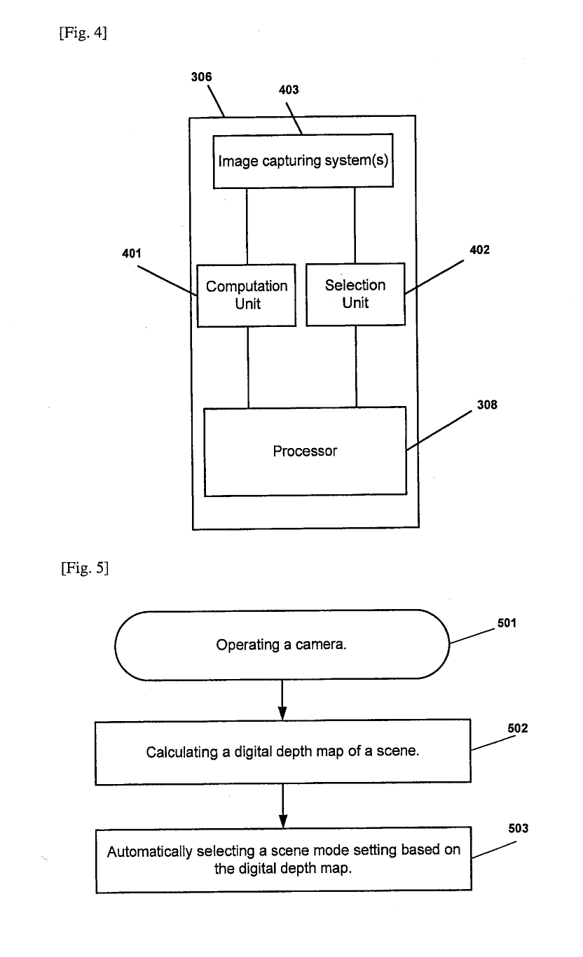

FIG. 4 is a simplified block diagram of a camera. FIG. 4 illustrates a computation unit 401 and a selection unit 402 that communicate with the processor 308 and one or more image capturing systems 403. In some embodiments, the computation unit 401 and the selection unit 402 may include any suitable combination of hardware, software, firmware, and/or circuitry. According to some embodiments, the computation unit 401 and the selection unit 402 may be implemented in the processor 308. The one or more image processing systems 403 may reside inside or outside the camera or may reside inside or outside the mobile device 301 of FIG. 3.

FIG. 5 is a flowchart of operations that may be performed to operate a camera to automatically select a scene mode setting based on a digital depth map by a system, method and/or computer program product according to various embodiments described herein. Referring to FIG. 5, a camera that is coupled to a mobile device or a standalone camera may be operated at Block 501, which may be embodied, for example, as mobile device 301 of FIGS. 3A-3D. For example, the camera may be a standalone camera, part of a mobile communications device, or be remotely located from the device. The camera may capture, sample, record, save, or otherwise process a scene. A digital depth map of a scene available to the camera may be calculated at Block 502. As used herein, “calculating” may include computation, arithmetic operations, logical operations, receipt of a data structure with digital depth map and/or related information, selecting of data values representing a digital depth map and/or table lookup. At Block 503, a scene mode setting out of a plurality of scene mode settings may be automatically selected based on the digital depth map of the scene. Moreover, the automatic selection of the scene mode setting may include other factors such as facial recognition, exposure levels, backlighting, object recognition, and/or color rendering, etc.

The scene mode setting may include sports mode, macro mode, movie mode, movie quality indication mode such that different image quality parameters are selected, night mode, snow mode, document mode, beach mode, food mode, fireworks mode, smile detection mode, steady shot mode, landscape mode, portrait mode, aperture priority mode, shutter priority mode, and/or sensitivity priority mode. Traditionally, the scene mode setting may be set by the user of the camera manually through a dial or other user input in the camera. Before taking a photograph or video, the user of the camera should determine the type of mode that may be well suited to the current conditions.

Various embodiments described herein may arise from recognition that manual setting by the user of the camera is based on the perception of the conditions by the user and also may be difficult and slow for the user to change as conditions change rapidly (i.e. conditions change within a few frames). In sharp contrast, automatic selection of the mode as described herein lends itself to the user being more agnostic about the technical operations of the camera and having a very large number of modes that allow for a variety of conditions, precision, and quick changes in the mode settings between few frames or even consecutive frames.

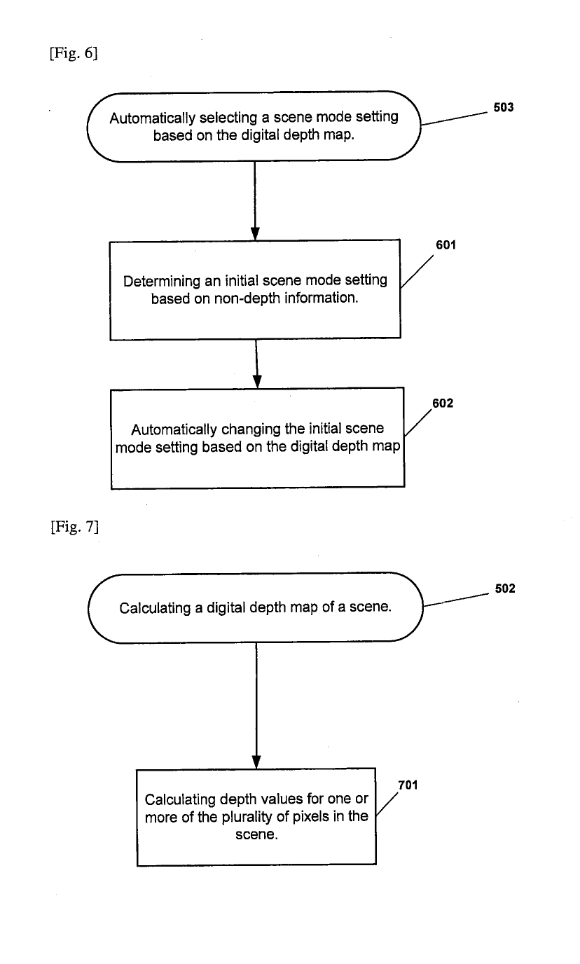

FIG. 6 is flowchart of operations that may be performed to automatically select a scene mode setting based on the digital depth map, which may correspond to Block 503 of FIG. 5. Referring to FIG. 6, at Block 601, automatically selecting one of the plurality of scene mode settings may be preceded by determining an initial scene mode setting out of the plurality of scene mode settings, based on non-depth information related to the scene. Non-depth information may include histogram data, color information, white balance, face detection, and/or focus position. The non-depth information may be utilized to determine the scene mode. At Block 602, the initial scene mode setting may be automatically changed based on the digital depth map of the scene.

FIG. 7 is a flowchart of operations that may be performed to calculate a digital depth map of a scene, which may correspond to Block 502 of FIG. 5. Referring to FIG. 7, at Block 701, depth values may be calculated for one or more of the plurality of pixels in the scene. Individual depth values for each pixel may be a representation of a distance of the particular point in the scene. According to some embodiments, automatically selecting one of the plurality of scene mode settings may further be based on non-depth information.

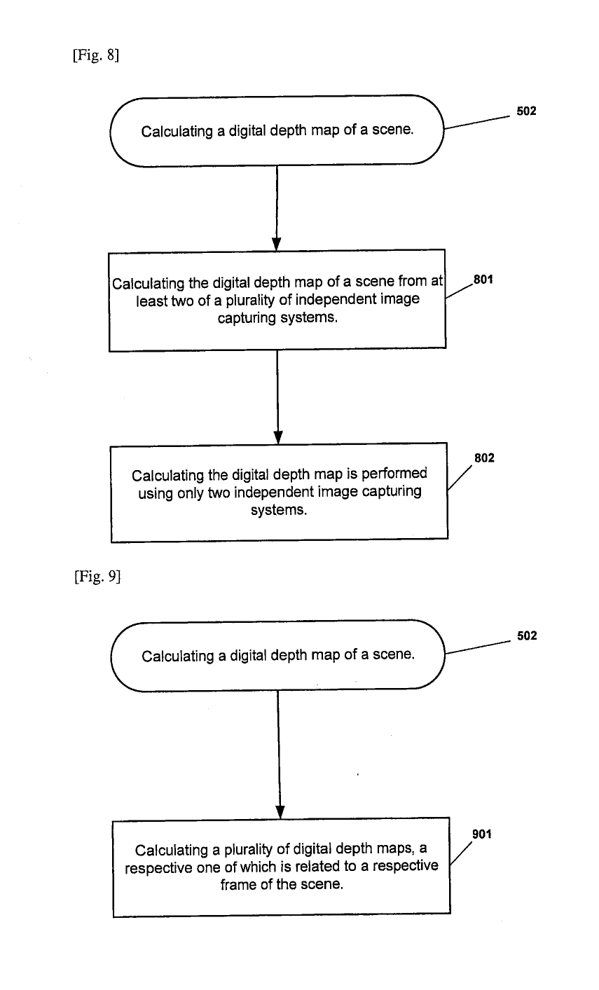

FIG. 8 is a flowchart of operations that may be performed to calculate a digital depth map of a scene, which may correspond to Block 502 of FIG. 5. Referring to FIG. 8, at Block 801, the digital depth map may be calculated using depth values associated with at least two of a plurality of independent imaging systems. For example, a stereo camera is a type of camera/imaging system with two or more lenses with a separate image sensor for each lens. The multiple lenses allow the camera to simulate human binocular vision, and therefore gives it the ability to capture three-dimensional images, i.e. calculate the depth map. An image capturing system may include two or more subcameras each with a separate image sensor to obtain information about the scene, as illustrated, for example, in FIG. 3C. At Block 802, the digital depth map may be calculated using only two of the plurality of the independent image capturing systems.

FIG. 9 is a flowchart of operations that may be performed to calculate a digital depth map of a scene, which may correspond to Block 502 of FIG. 5. Referring to FIG. 9, at Block 901, a plurality of digital depth maps, a respective one of which is related to a respective frame of the scene, may be calculated. According to some embodiments, a digital depth map may be calculated for every frame. In some embodiments, a digital depth map may be calculated for every Nth frame or for a frame after a given time interval has elapsed.

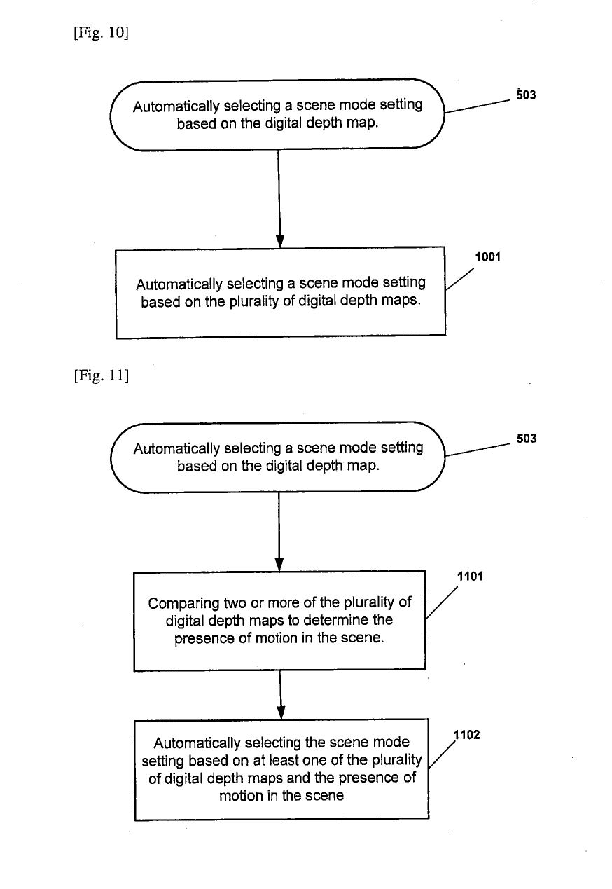

FIG. 10 is a flowchart of operations that may be performed to automatically select a scene mode setting based on the digital depth map, which may correspond to Block 503 of FIG. 5. Referring to FIG. 10, at Block 1001, a plurality of digital depth maps may be used to automatically select a scene mode setting.

FIG. 11 is a flowchart of operations that may be performed to automatically select a scene mode setting based on the digital depth map, which may correspond to Block 503 of FIG. 5. Referring to FIG. 11, at Block 1101, one of more of the plurality of digital depth maps are compared to determine the presence of motion in the scene. Then, at Block 1102, the scene mode setting is automatically selected based on at least one of the plurality of digital depth maps and the presence of motion in the scene. Factors such as rate of motion of one or more objects in the scene, number of objects moving, and variances in rates of motion of different objects in the scene may be considered in selecting the scene mode setting. The depth map may be averaged over multiple frames before making a decision to change the mode setting. Changes in the mode setting may be applied after a given number of frames or after a given number of time intervals such that the mode setting is not changed too often. The depth map may be sampled every Nth frame in order to reduce computational requirements.

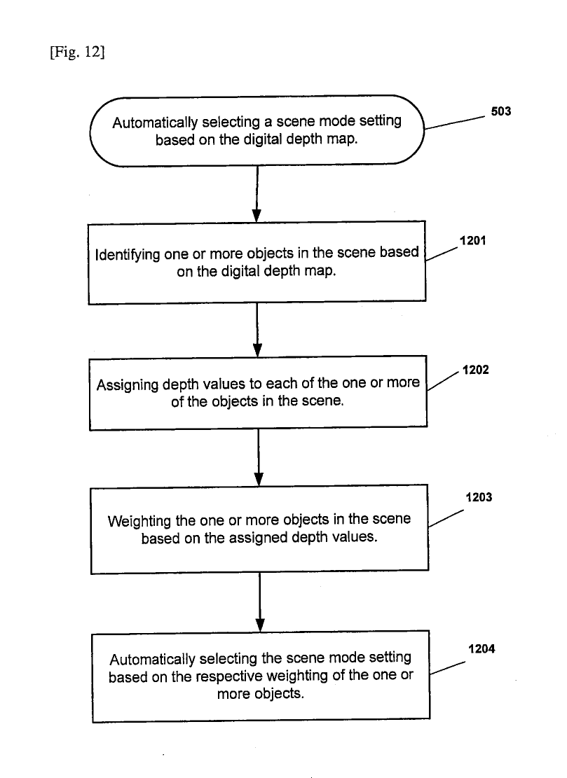

FIG. 12 is a flowchart of operations that may be performed to automatically select a scene mode setting based on the digital depth map, which may correspond to Block 503 of FIG. 5. Referring to FIG. 12, at Block 1201, one or more objects in the scene may be identified based on the digital depth map. At Block 1202, depth values are assigned to each of the one or more objects in the scene. At Block 1203, one or more objects in the scene are weighted based on the assigned depth values. At Block 1204, the scene mode setting is automatically selected based on the respective weighting of the objects.

According to some embodiments, the depth map may be used to provide a statistical basis for judging the correct scene mode that should be used. For example, an initial automatic scene recognition algorithm may select landscape as a proper scene to select. Depth map information could be used to determine if the selected landscape mode is a suitable choice. If the depth map statistically indicates that there are many objects near the camera, landscape mode may not be a suitable choice for the scene mode setting. In this case, the depth map may improve the accuracy of the scene recognition. In another example embodiment, the initial scene mode setting may indicate a food mode. Statistically, it may be expected that one or more objects in the scene may be a distance of one meter from the camera. If one or more objects are not found to be within one meter according to the depth map, then food mode may be incorrect and a different made may be selected.

According to some embodiments, the depth map information may be weighted among other types of information in order to determine a more accurate scene mode setting. In other words, the depth information may be used in conjunction with other non-depth information to select a scene mode setting. In some embodiments, depth information as well as non-depth information may be weighted together to select the scene mode setting.

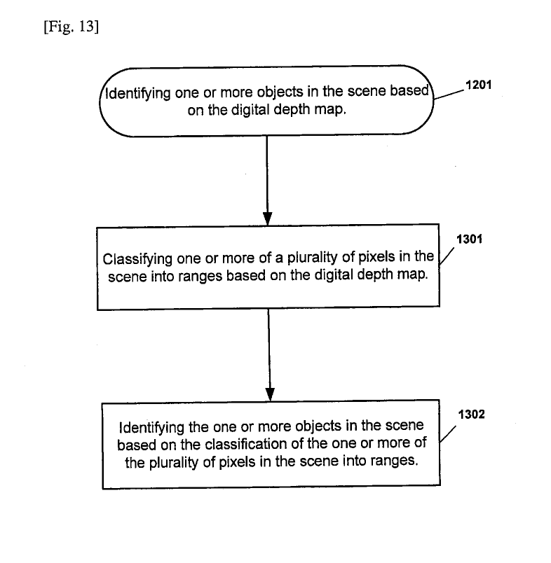

FIG. 13 is a flowchart of operations that may be performed to identify one or more objects in the scene based on the digital depth map, which may correspond to Block 1201 of FIG. 12. Referring to FIG. 13, at Block 1301, one or more of a plurality of pixels in the scene may be classified into ranges based on the digital depth map. Then, at Block 1302, based on the classification of the one or more of the plurality of pixels in the scene into ranges, one or more objects in the scene are identified. Pixels with in similar depth ranges may be identified as being related to a similar object whereas pixels with different depth ranges may be identified as being related to a different object.

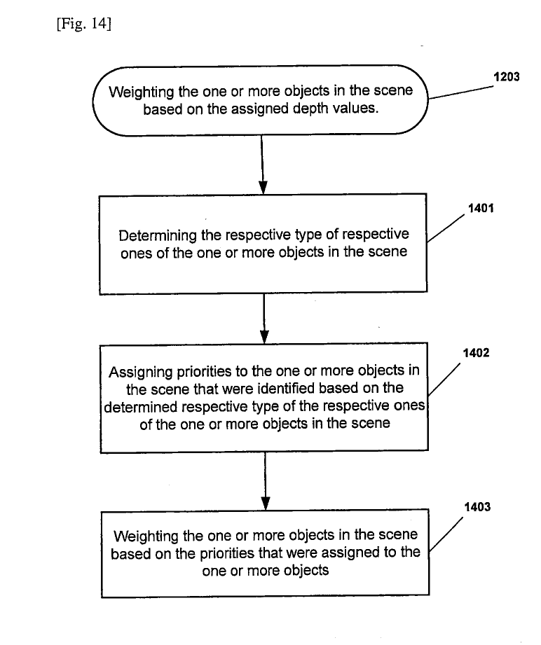

FIG. 14 is a flowchart of operations that may be performed to weight the one or more objects in the scene based on the assigned depth values, which may correspond to Block 1203 of FIG. 12. Referring to FIG. 14, at Block 1401, a respective type may be determined for respective ones of the one or more objects in the scene. For example, pixels in a first range may be identified as a first object while pixels in a second range may be identified as a second object in the scene. Then, at Block 1402, priorities are assigned to the one or more objects in the scene that were identified determined respective type of each of the objects. Then, at Block 1403, weighting of the one or more objects in the scene is accomplished based on the priorities that were assigned to the one or more objects.

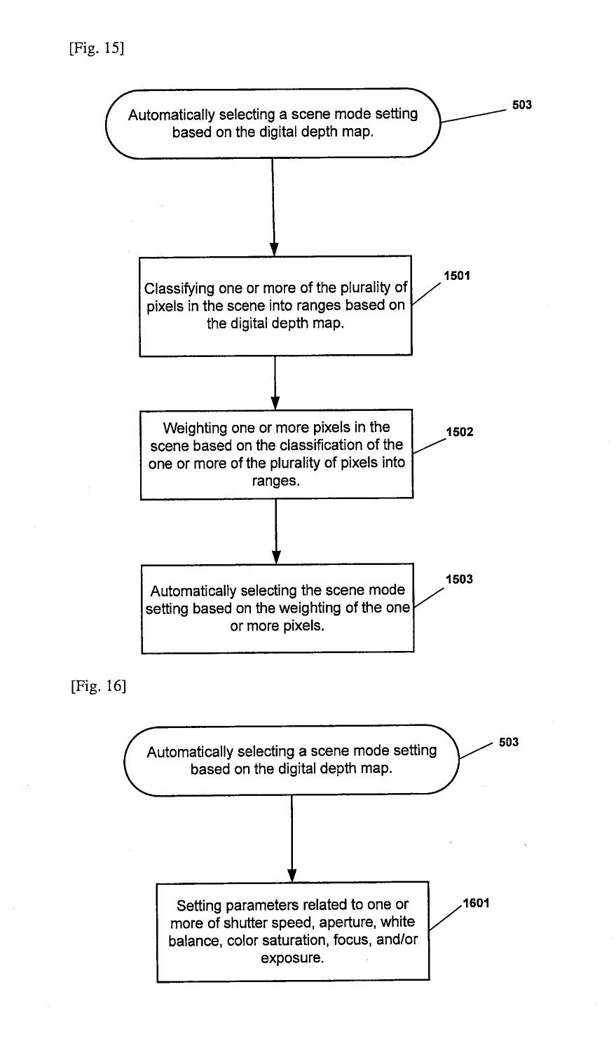

FIG. 15 is a flowchart of operations that may be performed to automatically select a scene mode setting based on the digital depth map which may correspond to Block 503 of FIG. 5. Referring to FIG. 15, at Block 1501, one or more of a plurality of pixels in the scene may be classified into depth ranges based on the digital depth map. Then, at Block 1502, one or more objects in the scene are weighted based on the classification of the pixels into depth ranges. At Block 1503, the scene mode setting is automatically selected based on the weighting of the pixels.

FIG. 16 is a flowchart of operations that may be performed to automatically select a scene mode setting based on the digital depth map which may correspond to Block 503 of FIG. 5. Referring to FIG. 16, at Block 1601 parameters related to shutter speed, aperture, white balance, color saturation, focus, and/or exposure may be adjusted.

One of ordinary skill in the art should recognize that the automatically selecting the scene mode setting based on the digital depth map is different from automatic focus functionality (i.e. “auto-focus” feature) of some cameras. Auto-focus has been implemented largely by two methods: active auto-focus and passive auto-focus. Active auto-focus uses ultrasonic and/or infrared waves to measure the distance to an object. The ultrasonic or infrared waves strike the object to be photographed and bounce back. A time period for the ultrasonic or infrared waves to return to the camera is measured in order to estimate the distance to the object. Based on the measured distance, an auto-focus setting may be applied. In contrast to active auto-focus, passive auto-focus typically uses two images from different parts of the lens to analyze light intensity patterns to calculate separation error. This separation error is calculated for a variety of focus settings. The camera determines the focus setting with maximum intensity difference indicated by the separation error between adjacent pixels and selects the respective focus setting. In other words, passive auto-focus tries a variety of focus settings and selects the best one, similar to the manual focus used by a photographer before the use of digital auto-focus cameras became prevalent.

In sharp contrast to active and passive auto-focus functionality, using embodiments as described herein include calculating a digital depth map of a scene that is received by the camera. A depth map includes digital information from multiple image capturing systems in order to determine depth or distance readings to the surface from a given point or camera location. Active auto-focus uses time measurements of ultrasonic or infrared wave reflections while passive auto-focus tests many focus settings and maximizes the intensity difference between pixels. However, neither active or passive auto-focus use a digital depth map to automatically select a scene mode setting as described herein.

Embodiments of the present disclosure were described herein with reference to the accompanying drawings. Other embodiments may take many different forms and should not be construed as limited to the embodiments set forth herein. Like numbers refer to like elements throughout.

It will be understood that, when an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Furthermore, “coupled”, “connected”, “responsive”, or variants thereof as used herein may include wirelessly coupled, connected, or responsive. Like numbers refer to like elements throughout. The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. Well-known functions or constructions may not be described in detail for brevity and/or clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive concept. Moreover, as used herein, the term “and/or” includes any and all combinations of one or more of the associated listed items.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, if used herein, the common abbreviation “e.g.”, which derives from the Latin phrase exempli gratia, may be used to introduce or specify a general example or examples of a previously mentioned item, and is not intended to be limiting of such item. If used herein, the common abbreviation “i.e.”, which derives from the Latin phrase id est, may be used to specify a particular item from a more general recitation.

Exemplary embodiments were described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit such as a digital processor, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). These computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BluRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, embodiments of the present inventive concept may be embodied in hardware and/or in software (including firmware, resident software, micro-code, etc.) that runs on a processor such as a digital signal processor, which may collectively be referred to as “circuitry,” “a module”, a “unit” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments were disclosed herein, in connection with the following description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

As used herein, the term “mobile device” includes cellular and/or satellite radiotelephone(s) with or without a multi-line display; Personal Communications System (PCS) terminal(s) that may combine a radiotelephone with data processing, facsimile and/or data communications capabilities; Personal Digital Assistant(s) (PDA) or smart phone(s) that can include a radio frequency transceiver and a pager, Internet/Intranet access, Web browser, organizer, calendar and/or a global positioning system (GPS) receiver; and/or conventional laptop (notebook) and/or palmtop (netbook) computer(s) or other appliance(s), which include a radio frequency transceiver. As used herein, the term “mobile device” also includes any other radiating user device that may have time-varying or fixed geographic coordinates and/or may be portable, transportable, installed in a vehicle (aeronautical, maritime, or land-based) and/or situated and/or configured to operate locally and/or in a distributed fashion over one or more terrestrial and/or extra-terrestrial location(s). As used herein, the term “mobile device” also includes standalone cameras whose primary function is to capture pictures and video.

In the drawings and specification, there have been disclosed embodiments of the inventive concept and, although specific terms are employed, they are used in a generic and descriptive sense only and not for purposes of limitation, the scope of the inventive concept being set forth in the following claims.

1. A method of operating a camera comprising:
calculating a digital depth map of a scene that is received by the camera; and
automatically selecting one of a plurality of scene mode settings for the scene based on the digital depth map of the scene.

2. The method of claim 1,
wherein automatically selecting one of the plurality of scene mode settings is preceded by determining an initial scene mode setting out of the plurality of scene mode settings, based on non-depth information related to the scene; and
wherein automatically selecting one of the plurality of scene mode settings comprises automatically changing the initial scene mode setting based on the digital depth map of the scene.

3. The method of claim 1,
wherein automatically selecting one of the plurality of scene mode settings comprises automatically selecting one of a plurality of scene mode settings for the scene based on the digital depth map of the scene and further based on non-depth information.

4. The method of claim 1,
wherein the scene comprises a plurality of pixels, and
wherein the calculating the digital depth map comprises calculating a depth value for one or more of the plurality of pixels in the scene.

5. The method of claim 1,
wherein the camera comprises a plurality of independent image capturing systems; and
wherein the calculating the digital depth map comprises calculating a digital depth map of a scene from at least two of the plurality of independent image capturing systems.

6. The method of claim 5, wherein the calculating is performed using only two of the plurality of the independent image capturing systems.

7. The method of claim 1,
wherein the calculating the digital depth map comprises calculating a plurality of digital depth maps, a respective one of which is related to a respective frame of the scene; and
wherein automatically selecting one of the plurality of scene mode settings comprises automatically selecting one of the plurality of scene mode settings based on the plurality of digital depth maps.

8. The method of claim 1,
wherein the calculating the digital depth map comprises calculating a plurality of digital depth maps, a respective one of which is related to a respective frame of the scene;
wherein automatically selecting one of the plurality of scene mode settings comprises comparing two or more of the plurality of digital depth maps to determine the presence of motion in the scene; and
wherein automatically selecting one of the plurality of scene mode settings further comprises automatically selecting the scene mode setting based on at least one of the plurality of digital depth maps and the presence of motion in the scene.

9. The method of claim 1, wherein automatically selecting one of the plurality of scene mode settings for the scene based on the digital depth map of the scene comprises:
identifying one or more objects in the scene based on the digital depth map;
assigning depth values to each of the one or more of the objects in the scene;
weighting the one or more objects in the scene based on the assigned depth values; and
automatically selecting the scene mode setting based on the respective weighting of the one or more objects.

10. The method of claim 9, wherein identifying the one or more objects in the scene based on the digital depth map comprises:
classifying one or more of a plurality of pixels in the scene into depth ranges based on the digital depth map; and
identifying the one or more objects in the scene based on the classification of the one or more of the plurality of pixels in the scene into depth ranges.

11. The method of claim 9, wherein weighting the one or more objects in the scene based on the assigned depth values comprises:
determining the respective type of respective ones of the one or more objects in the scene;
assigning priorities to the one or more objects in the scene that were identified based on the determined respective type of the respective ones of the one or more objects in the scene; and
weighting the one or more objects in the scene based on the priorities that were assigned to the one or more objects.

12. The method of claim 1, wherein automatically selecting one of the plurality of scene mode settings for the scene based on the digital depth map of the scene comprises:
classifying one or more of the plurality of pixels in the scene into depth ranges based on the digital depth map;
weighting one or more pixels in the scene based on the classification of the one or more of the plurality of pixels into depth ranges; and
automatically selecting the scene mode setting based on the weighting of the one or more pixels.

13. The method of claim 1, wherein the scene mode setting comprises sports mode, macro mode, movie mode, night mode, steady shot mode, landscape mode, portrait mode, snow mode, document mode, beach mode, food mode, and/or fireworks mode.

14. The method of claim 1, wherein automatically selecting one of the plurality of scene mode settings for the scene based on the digital depth map of the scene comprises:
setting parameters related to shutter speed, aperture, white balance, color saturation, focus, and/or exposure.

15. A device for operating a camera, comprising:
a computation unit configured to calculate a digital depth map of a scene that is received by the camera; and
a selection unit configured to automatically select one of a plurality of scene mode settings for the scene based on the digital depth map of the scene.

16. The device of claim 15,
wherein the selection unit is further configured to precede automatically selecting one of the plurality of scene mode settings by determining an initial scene mode setting out of the plurality of scene mode settings, based on non-depth information related to the scene; and
wherein the selection unit is further configured to automatically select one of the plurality of scene mode settings by automatically changing the initial scene mode setting based on the digital depth map of the scene.

17. The device claim 15, wherein the selection unit is further configured to:
identify one or more objects in the scene based on the digital depth map;
assign depth values to each of the one or more of the objects in the scene;
weight the one or more objects in the scene based on the assigned depth values; and
automatically select the scene mode setting based on the respective weighting of the one or more objects.

18. The device of claim 17, wherein the selection unit is further configured to:
classify one or more of a plurality of pixels in the scene into depth ranges based on the digital depth map; and
identify the one or more objects in the scene based on the classification of the one or more of the plurality of pixels in the scene into depth ranges.

19. The device claim 17, wherein the selection unit is further configured to:
determine the respective type of respective ones of the one or more objects in the scene;
assign priorities to the one or more objects in the scene that were identified based on the determined respective type of the respective ones of the one or more objects in the scene; and
weight the one or more objects in the scene based on the priorities that were assigned to the one or more objects.

20. A computer program product for operating a camera, the computer program product comprising a computer readable storage medium having computer readable program code embodied therein, the computer readable program code comprising:
computer readable program code that is configured to calculate a digital depth map of a scene that is received by the camera; and
computer readable program code that is configured to automatically select one of a plurality of scene mode settings for the scene based on the digital depth map of the scene.
